(19) United States
(12) Patent Application Publication
(10) Pub. No.: US 2015/0138121 A1
(43) Pub. Date: May 21, 2015

(54) DEVICE FOR OPERATING GRAPHIC ARTS MACHINES AND DEVICES HAVING A DISPLAY DEVICE WITH A TOUCH OPERATION WALL SCREEN

(71) Applicant: HEIDELBERGER DRUCKMASCHINEN AG, Heidelberg (DE)

(72) Inventors: EDELBERT KOENIG, KRONAU (DE); DIETER HAUCK, EBERBACH (DE)

(21) Appl. No.: 14/548,849

(22) Filed: Nov. 20, 2014

(30) Foreign Application Priority Data
Nov. 20, 2013 (DE) 102013019425.3

(51) Int. Cl. G06F 3/041; G06F 3/12; G06F 3/01

(52) U.S. Cl. CPC G06F 3/041; G06F 3/017; G06F 3/1201
USPC 345/173

(57) ABSTRACT

A device for operating machines and devices of the graphic arts industry includes a display device, an operating device with a touch screen for operating functions of the graphic arts machine or device and for influencing a representation on the display device, and a communication link between the operating device and the display device. The same screen content is shown on the operating device and on the display device and the touch screen of the operating device is used to modify the screen content on the operating device and on the display device in parallel.

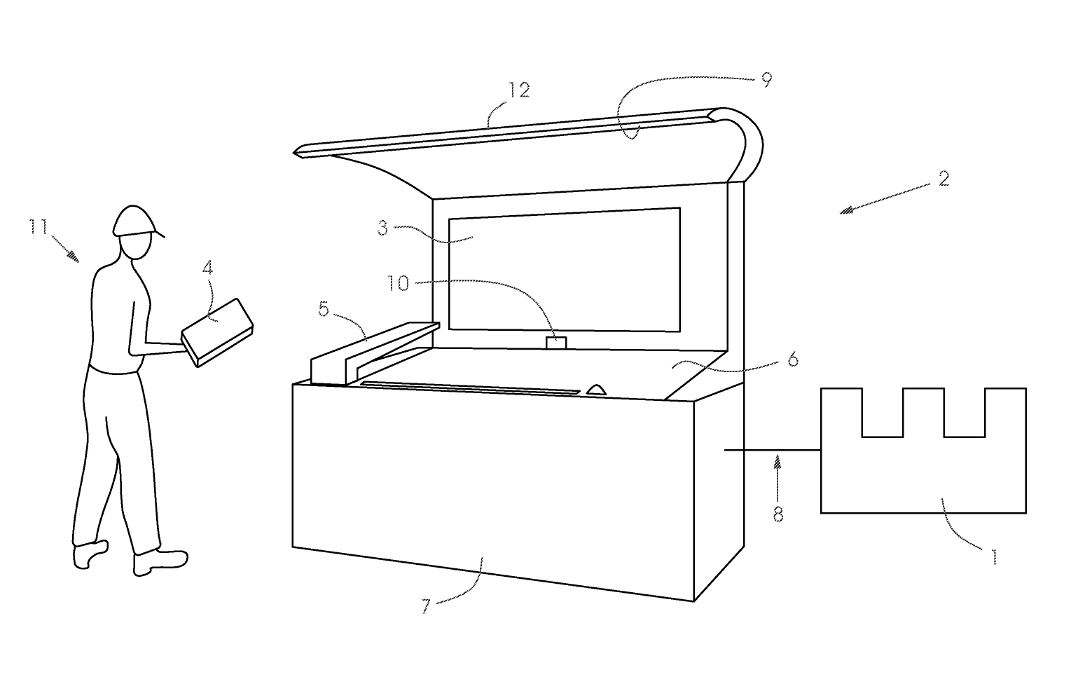

### CROSS-REFERENCE TO RELATED APPLICATION

This application claims the priority, under 35 U.S.C. §119, of German Patent Application DE 10 2013 019 425.3, filed Nov. 20, 2013; the prior application is herewith incorporated by reference in its entirety.

### BACKGROUND OF THE INVENTION

### Field of the Invention

The present invention relates to a device for operating graphic arts machines and devices that have a display device.

Such a device is known, for example, from German Patent Application DE 10 2007 058 708 A1, which discloses an operating concept for printing presses with at least one computer, an operating device, an input device, and an output device. The computer of the machine processes at least two signals from the group of acoustic, haptic, or optical information. That means that the printing press operator has at least two ways of receiving information. Likewise, the printing press operator may input control commands using a keyboard or voice recognition through a microphone, for example. Moreover, a camera is provided to recognize the operators' gestures and to record the operators' hand movements, which will then be translated into corresponding control commands to control the printing press.

### SUMMARY OF THE INVENTION

It is accordingly an object of the invention to provide a device for operating graphic arts machines and devices having a display device with a touch operation wall screen, which overcomes the hereinafore-mentioned disadvantages of the heretofore-known devices of this general type.

With the foregoing and other objects in view there is provided, in accordance with the invention, a device for operating machines and devices of the graphic arts industry. The device comprises a display device, an operating device with a touch screen for operating the functions of the graphic arts machine or device and for influencing the representation on the display device, and a communication link between the operating device and the display device, wherein the same screen content is shown on the operating device and on the display device and wherein the touch screen of the operating device is used to modify the screen content on the operating device and on the display device in parallel.

The present invention is distinguished by the fact that an operating device including a touch screen is provided to control the functions of the graphic arts machine or device and to influence the representation on the display device, and by the fact that a communication link is provided between the operating device and the display device. In addition to the display device for representing the operating condition of the graphic arts machine or device and for displaying operating data, the operating device of the invention includes an operating device with a touch screen for controlling the display device and the machine or device. The touch screen likewise includes a screen that allows parts or entire images that are displayed on the display device to also be displayed on the touch screen. The operating device that includes the touch screen and the display device are interconnected by a wireless or wired communication link. Furthermore, the display device and/or the operating device that includes the touch screen may include a computer or may be connected to a computer. The operating device that includes the touch screen may be stationary and fixed to the control panel of the machine. Alternatively, the user interface that includes the touch screen may be a mobile operating unit.

The device of the invention is particularly suited for operating printing presses that have a so-called wall screen as a display device. Wall screens are large screens disposed on the control console of the printing press. They usually have a screen size of 52 inches, allowing them to display large printing materials of a 100 cm×70 cm format in their original size. Since the wall screen is generally disposed in the rear region on the rear wall of the control console, corresponding operating elements need to be provided in addition to the wall screen because otherwise the printing press operator would not be able to make inputs to operate the machine. In accordance with the invention, it is the operating device that includes the touch screen that takes over this function. The operating device that includes the touch screen virtually acts as the extended arm of the printing press operator, making additional pointing tools such as a computer mouse or a pen superfluous. In this way, the display device and the operating device that includes the touch screen provide a simple, intuitive way of operating the printing press since the screen content of the display device and of the operating device that includes the touch screen are synchronized with each other at all times due to the communication link and a computer. Thus, the printing press operator sees exactly the same image content (at least in sections) on the touch screen of the operating device and on the display device and is capable of intuitively influencing the representation on the display device by inputs on the touch screen. In accordance with the invention, a provision is made for the operating device and the display device to display the same screen content and for the screen content of the operating device and of the display device to be modifiable in parallel using the touch screen of the operating device. In this way, the content on the display device may be directly synchronized with the touch screen of the operating device to be directly operable thereon. Indirect operation by using a mouse or a touch pad without a screen display is not required. Furthermore, the display device and the touch screen of the operating device may be controlled based on the same operational concept or philosophy. This means that the printing press operator may see the same screen content on the touch screen and on the display device, a fact which simplifies operation of the printing press to a considerable extent. Moreover, this fact significantly simplifies programming of the control unit of the printing press because no different operating concepts need to be implemented and maintained. Instead, the operating concept on the display device and on the touch screen of the operating device are identical, with the operator inputs made exclusively on the touch screen and not on the display device, because the latter does not need to have a touch screen function.

In accordance with another feature of the invention, the operating device and the display device are interconnected by a wireless communication link. This allows the operator to use the operating device that includes the touch screen in any desired location in the press room and to make remote inputs with the display device in sight.

In accordance with a further feature of the invention, the operating device may be a mobile operating device such as a smartphone or a tablet computer. It is likewise possible for the mobile operating device or display device to be a bracelet display such as a watch that includes a display, which is frequently referred to as a smartwatch. In this case, no special hardware is required as the operating device that includes the touch screen. In principle, any desired tablet computer or any desired smartphone having a conventional operating system such as Android or Apple IOS may be used once the corresponding user interface for controlling printing presses has been uploaded thereon. The wireless communication may then be implemented by the radio data transmission integrated in the smartphone or tablet computer, for example by WLAN or Bluetooth.

In accordance with an added feature of the invention, the display device has a computer and the computer has a touch screen user interface for operating the graphic arts machine or device stored or generated thereon. The touch screen user interface may be transmitted to the operating device over the communication link. This embodiment is, in particular, suitable for integrating mobile operating devices such as a smartphone or a tablet computer into the operation of the graphic arts machine or device. In this case, a method of radio data transmission such as a WLAN or Bluetooth or UMTS is used to couple the smartphone or tablet computer to the control unit of the graphic arts machine or device, which is likewise equipped with a network connection. Once the connection has been established and authorized, the software for operating the touch screen user interface is transmitted and installed in accordance with the respective operating system of the smartphone or tablet computer. In this way, the smartphone or tablet computer may quickly and easily be coupled to the control unit of the machine or device to be put into operation. It is likewise possible to enable operation through a browser of the mobile operating device. In this case, the screen content for controlling the machine using the mobile operating device is generated in the computer of the machine control unit and transmitted to the mobile operating device as required. In this case, the installation of software on the mobile operating device is not necessary.

In accordance with an additional particularly preferred feature of the invention, the screen content of the display device may be scaled down to be displayed on the operating device or may be displayed in sections thereon. Since in most cases, the touch screen of the operating device will be of a much smaller size (10 inches at the maximum) than the large-format display device (52 inches at the minimum), in is very advantageous if in a first step, the screen content of the display device is adapted to the format of the touch screen of the operating device. For this purpose, the screen content of the display device may be displayed on the touch screen in an enlarged view and in sections or regions. Even if the touch screen has the same high resolution as the display device, it is nevertheless expedient to enlarge the screen content and display it in sections because otherwise the operator would have to hold the touch screen too close to his or her eyes to be able to recognize the content.

In accordance with yet another advantageous feature of the invention, the same screen masks or forms may be displayed on the display device and on the operating device. In order to simplify the enlargement and the display in sections, in principle, the same screen masks or forms are shown on the display device and on the touch screen of the operating device. However, due to the larger size, the display device may display multiple screen masks at the same time, whereas the operating device only displays one screen mask or form. This is possible because the screen of the display device is subdivided into multiple sections or regions having a size which corresponds to the resolution of the screen of the operating device. In this case, no complicated computing processes are required to adapt the representation of the screen content of the display device to the format of the touch screen of the operating device. Instead, it is sufficient to display the relevant section of the screen of the display device across the entire format of the touch screen of the operating device, automatically causing the representation of the respective required section to be enlarged. The selection of the respective required section may be made by corresponding swiping gestures or touches that are used on the touch screen to switch between the respective sections or regions on the display device. In terms of size, the image content on the display device is preferably divided into regions that may be displayed on the touch screen of the operating device in a size that allows them to be operated by the printing press operator using his or her finger. Once an operating process on the touch screen has be completed, it is possible for a transmission of image content from the touch screen of the operating device to the display device to likewise be initiated by a corresponding touch or a simple swiping gesture in the direction of the display device. Depending on the settings, it is possible for the screen content to be exchanged or to be duplicated to be displayed on both screens.

In accordance with yet a further feature of the invention, the screen content on the display device may include multiple touch screen applications of the operating device. In this case, the content of the display device includes multiple application modules of the touch screen of the operating device. Touches or swiping gestures cause the respective touch screen application to be selected and made operable. For example, eight touch screen applications may be available on the operating device, each one corresponding to the format of the touch screen of the operating device to be displayed thereon.

Using the operating device that includes a touch screen, it is likewise possible for the touch screen to be switched to a so-called touch pad mode, for example to create detailed drawings for highlighting certain areas on the touch screen of the operating device. This is particularly expedient for the selection of areas to be inspected when a printed image on a printed sheet is to be examined. While the display device displays the entire printed sheet, the touch screen of the operating device only displays one section and the printed sheet is displayed on an enlarged scale. Then the operator may select a suitable region on the touch screen using the touch pad function to allocate specific image inspection tasks and rules to the selected region. For better operation, a pen instead of a finger may be used to mark the selected inspection area on the touch screen. In particular, a so-called graphics tablet may be used for this purpose instead of a smartphone or tablet computer that has a corresponding drawing program. The graphics tablet may likewise be equipped with a screen, which may be operated by pen inputs. Compared to operation by finger, operation by pen facilitates the creation of drawings on a small touch screen. In this context, in accordance with a particularly advantageous feature, the touch screen may be constructed to be operable both by a finger and by a pen.

In accordance with yet an added feature of the invention, the screen content on the display device may contain operating elements and the operating elements of the display device may be displayed on the operating device. In this case, the operating elements of all or some areas of the touch screen applications of the large display device may be filtered to be displayed on the touch screen of the operating device in a specific order. This allows all operating elements to be compressed onto the small format of the touch screen of the operating device.

In accordance with yet an additional feature of the invention, it may be possible to switch between the areas or touch screen applications on the operating device by swiping gestures. This allows the operator to conveniently and easily switch between individual areas or applications by swiping gestures on the touch screen, moving to the right or to the left, upward or downward or even diagonally, to always see precisely the desired application or area on the touch screen.

In accordance with a concomitant feature of the invention, it is possible for the operation of the display device through the touch screen of the operating device to be combined with a control unit for recognizing gestures in space. In this case, in addition to operating the machine or device by using the touch screen, the operator may use finger gestures in space that are recognized by corresponding sensors or cameras on the control console to control the graphic arts machine or device.

Other features which are considered as characteristic for the invention are set forth in the appended claims.

Although the invention is illustrated and described herein as embodied in a device for operating graphic arts machines and devices which have a display device with a touch operation wall screen, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

The FIGURE of the drawing is a diagrammatic, perspective view of a control console of a printing press that includes an operating device according to the invention.

### DETAILED DESCRIPTION OF THE INVENTION

Referring now in detail to the single FIGURE of the drawing, there is seen a control console 2 of a graphic arts machine in the form of a printing press 1 which is equipped with a rear wall. A display device or wall screen 3 is attached to the rear wall. This wall screen 3 is preferably a large screen of 52 to 70 inches. Even large-format print sheets may be displayed in their original size on such a large screen. An upper region of the control console 2 has a roof 12 to keep environmental light away from a sheet deposition surface disposed below the wall screen 3. The roof 12 supports a color control lamp 9, which allows sheets 6 resting on the sheet deposition surface to be illuminated by standardized light. In addition, the sheet 6 may be scanned by a graphic arts device in the form of a color measurement device 5. The wall screen 3 and the color measurement device 5 are connected to a control computer 7 of the printing press 1. The control computer 7 in turn communicates with a control unit of the printing press 1 through a communication link 8. Furthermore, the control computer 7 is connected to a receiving/transmitting unit 10, which is preferably a wireless unit, in particular one that is equipped with a WLAN or Bluetooth connection to communicate with an operating device 4 having a mobile touch screen. This operating device 4 having the mobile touch screen may, in particular, be a smartphone or a tablet computer equipped with suitable software that includes a user interface for controlling the printing press 1 and the color measurement device 5. In this way, it is possible for an operator 11 to conveniently operate the printing press 1 and the color measurement device 5 even if the operator is not directly at the control console 2.

In principle, the same screen content may be displayed on the wall screen 3 and on the operating device 4 having the mobile touch screen. However, due to the fact that the operating device 4 having the mobile touch screen is much smaller (10 inches at the maximum in most cases), the representation needs to be adapted in a way that makes sense. For this purpose, the content on the wall screen 3 is scaled down in a suitable way, i.e. its size is adapted to the format of the operating device 4 having the mobile touch screen. This is possible in a particularly simple way if the wall screen 3 is subdivided into corresponding regions having a size which corresponds to the format of the operating device 4 having the mobile touch screen. In this case, these regions on the wall screen 3 may be displayed on the touch screen one-to-one without requiring the control computer 7 to make calculations to adapt the format. Of course, it is likewise possible to enlarge screen content of the wall screen 3 in sections using a zooming function to display the screen content in a readily readable way on the operating device 4 having the mobile touch screen. The selection of the respective regions is made by gestures on the operating device 4 having the mobile touch screen, in particular by swiping gestures, which allow the operator to seamlessly move from one screen content to the next in a different region without any difficulty. Data are transferred from the operating device 4 having the mobile touch screen to the wall screen 3 and vice versa by suitable swiping gestures in the respective direction.

The operating device 4 having the mobile touch screen may be constructed in such a way that it contains more than the user interface for a single printing press 1. It is possible for the mobile touch screen to be used to control multiple printing presses 1, switching between user interfaces by suitable touches or swiping gestures or implementing and recognizing data transfers or control operations by gesture recognition, i.e. by recognizing the direction of gestures towards the respective wall screen 3 of the associated printing press 1. Analogously, it is possible for one printing press 1 to be controlled by multiple operating devices 4 having mobile touch screens. In addition, it is possible for the wall screen 3 to be equipped with a surface that is sensitive to touches. This embodiment is technically complex and expensive because large touch screens of a size like that of the wall screen 3 are unusual. If desired, however, it is technically possible to provide such a touch screen surface for the wall screen 3 in order to additionally allow the operator 11 to make inputs directly on the wall screen 3, in particular when the operator 11 is immediately in front of the control console 2, for example to examine a printing substrate 6 resting thereon and to bend over the printing substrate 6 anyway. Moreover, an additional or alternative operating device 4 having a mobile touch screen may be installed to be stationary in the front region of the control console 2.

Since the user interfaces on the wall screen 3 and on the operating device 4 having the mobile touch screen are the same, the operator 11 will be able to operate both interfaces intuitively because in principle, the same screen content is shown on the wall screen 3 and on the operating device 4 having the mobile touch screen and it is only the size which is modified and the screen content is shown in sections. This provides an intuitive and safe way of operating the printing press, significantly improving the ease of operation of graphic arts machinery and devices. Furthermore, it is possible to distinguish between applications that are exclusively used for displaying purposes and applications that are exclusively used for operating purposes. In this context, it is possible to represent the displaying applications on the wall screen 3 only, because they do not require direct operations, whereas all applications or at least all applications that include operating elements are displayed on the operating device 4 having the mobile touch screen, which allows suitable inputs to be made by the operator 11. Applications without operating functions are then exclusively displayed on the wall screen 3. Conveniently, swiping gestures may be used to switch between applications on the operating device 4 having the mobile touch screen.

1. A device for operating machines and devices of the graphic arts industry, the device comprising:
a display device having a screen content;
an operating device having a screen content and a touch screen, said touch screen of said operating device configured to operate functions of the graphic arts machine or device, to influence a representation on said display device and to modify said screen content on said operating device and said screen content on said display device in parallel; and
a communication link between said operating device and said display device configured to cause said screen content shown on said operating device and said screen content shown on said display device to be the same.

2. The device according to claim 1, wherein said communication link interconnecting said operating device and said display device is a wireless communication link.

3. The device according to claim 1, wherein said operating device is a mobile operating device.

4. The device according to claim 4, wherein said mobile operating device is a smartphone or a tablet computer.

5. The device according to claim 1, which further comprises a computer associated with said display device, said computer configured to store or generate a touch screen user interface for operating the graphic arts machine or device and to transfer said touch screen user interface over said communication link to said operating device.

6. The device according to claim 1, wherein said display device is fixed to a control console of the graphic arts machine or device.

7. The device according to claim 1, wherein said screen content of said display device is shown on said operating device on an enlarged scale or in sections.

8. The device according to claim 1, wherein said display device has a screen, said operating device has a screen, and said screen of said display device is subdivided into multiple regions each corresponding to a size or resolution of said screen of said operating device.

9. The device according to claim 1, wherein said screen content on said display device includes multiple touch screen applications of said operating device.

10. The device according to claim 1, wherein said screen content on said display device contains operating elements, and said operating elements of said display device are displayed on said operating device.

11. The device according to claim 8, wherein said operating device is configured to allow swiping gestures to be used to switch between said regions.

12. The device according to claim 9, wherein said operating device is configured to allow swiping gestures to be used to switch between said touch screen applications.
